(19) United States
(12) Patent Application Publication
(10) Pub. No.: US 2006/0113060 A1
(43) Pub. Date: Jun. 1, 2006

(54) Air conditioner of an air conditioning system of a motor vehicle

(76) Inventors: Reinhold Burr, Heidenheim (DE); Michael Herrmann, Stuttgart (DE); Jochen Schaudt, Albstadt (DE); Thomas Spranger, Stuttgart (DE)

Correspondence Address: FOLEY AND LARDNER LLP;SUITE 500, 3000 K STREET NW, WASHINGTON, DC, 20007, US

(21) Appl. No.: 10/559,608

(22) PCT Filed: Jun. 1, 2004
(86) PCT No.: PCT/EP04/05896

§ 371 Date: Dec. 2, 2005

(30) Foreign Application Priority Data
Jun. 4, 2003 (DE) 10325499A

(51) Int. Cl. B60H 1/00; F28D 1/06; F28F 7/00; F28F 13/12; F24H 3/06

(52) U.S. Cl. 165/11.1; 165/72; 165/81; 165/122

(57) ABSTRACT

The invention relates to an air conditioner of an air conditioning system of a vehicle, comprising a housing with a removable housing cover, in which the following components are arranged: at least one blower motor, at least one impeller, at least one blower motor mounting and at least one motor regulator. According to the invention, said components are arranged in cover (1) of the housing, especially in the inner side (3) thereof.

The invention relates to an air conditioner of an air conditioning system of a motor vehicle, comprising a housing, having a removable housing cover, in which the following components are arranged: at least one blower motor, at least one impeller, at least one blower motor mounting and at least one motor regulator.

Air conditioners of the type mentioned serve the purpose of creating a desired climate in a passenger cell or in a loading space of a motor vehicle, in particular of undertaking cooling in the summer months. Since only limited conditions of room are available in a vehicle for accommodating the air conditioner, it is frequently necessary to mount the unit at a site accessible from the outside only very poorly. Consequently, its components can be reached only with great effort or, sometimes, under very poor conditions, for example without vision.

The invention is therefore based on the object of providing an air conditioner of the type mentioned at the beginning that is of more maintenance friendly design. The aim is also to create a solution that is cost effective and of simple design. This object is achieved according to the invention by arranging the components on the housing cover, in particular on its inner side. This solution permits the components located on the housing cover to be taken out as a whole after releasing the removable housing cover, such that in the taken-out state these components can be accessed very conveniently and simply. Advantages accrue even as early as when mounting the air conditioner, since the said components are fastened on the housing cover and then the entire structural unit can be fastened as a whole on the air conditioner. Consequently, not only is a large degree of maintenance friendliness implemented, but savings in mounting costs result from the present design.

It is provided according to a development of the invention that the blower motor mounting comprises a decoupler. The vibrations occurring during the operation of the blower motor are therefore passed onto the housing cover in a much reduced fashion in a way that avoids vibrations from being induced into the housing, and thereby avoids shocks and/or troublesome noise. This is also particularly significant because the said components are located on a releasable part, specifically on the housing cover.

It is also advantageous when a section of a spiral housing assigned to the impeller is located on the housing cover. The blower of the air conditioner has the impeller driven by the blower motor but whose optimum air conveying effect is only developed in cooperation with an impeller housing, in particular a spiral housing. An improvement in design results from the fact that there is arranged on the housing cover a section of the spiral housing designed in such a way that the impeller revolving in the spiral housing can be removed without any problem upon removal of the housing cover from the spiral housing. Given such a division of the spiral housing into a number of parts, it can be provided that at least one further section or the entire remainder of the spiral housing can be fastened on the section located on the housing cover, and thus that the entire spiral housing can also be taken out of the air conditioner housing upon removal of the housing cover. In order to demount the impeller revolving in the spiral housing, it is then necessary in the removed state of the housing, only to release the connection between the spiral housing parts. In particular, it is possible to proceed in such a way that the section assigned to the housing cover is a housing half. That is to say a separating joint of the spiral housing runs in the region of the axis of rotation of the impeller. A further result of the design explained above is that tolerance problems between the spiral housing and the propeller are avoided, since the impeller position is defined by the position of the blower motor and of the blower motor mounting, and is set in a corresponding way on the basis of the arrangement of these parts on the housing cover. Since the section of the spiral housing is likewise located on the housing cover, the impeller and section of the spiral housing exhibit a defined position relative to one another, the result being to prevent the undesired occurrence of contact that would lead to rubbing of the impeller against the spiral housing.

It is also important that the section of the spiral housing can be designed in one piece with the housing cover. Mounting costs of the spiral hosing are eliminated in the case of such a design. Furthermore, a high dimensional precision of the parts is provided, and therefore also is a correspondingly accurate positioning.

One development of the invention provides that the housing cover has a receptacle for the blower motor mounting and/or a receptacle for the motor regulator. These receptacles can also preferably be integrated in the housing cover. Because of the especially preshaped receptacles, it is possible for the blower motor mounting and/or of the motor regulator to be mounted in a very simple and accurate way.

Finally, it is advantageous when other components of the air conditioner are arranged on the housing cover, in particular at least one positioning motor and/or at least one air flap and/or at least one temperature sensor and/or at least one air filter and/or at least one electric cable. The more components there are arranged on the housing cover, in particular on its inner side, the more the inventive air conditioner turns out to be friendly in terms of maintenance and/or mounting.

The drawing illustrates the invention with the aid of an exemplary embodiment, specifically:

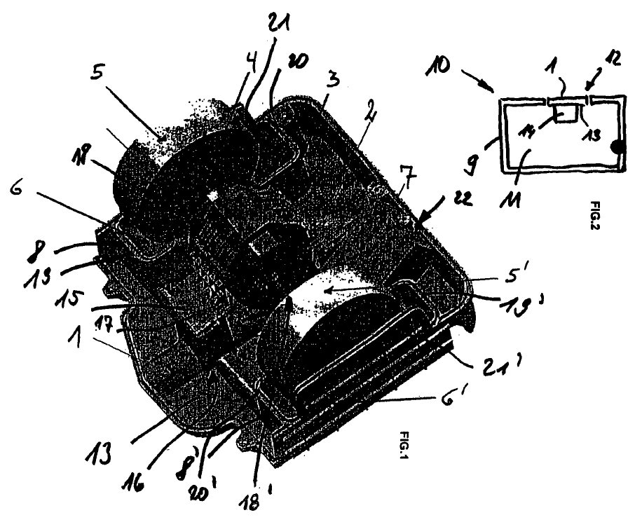

FIG. 1 shows a perspective view of a housing cover, provided with components, of a housing of an air conditioner of an air conditioning system of a vehicle, in a schematic illustration, and

FIG. 2 shows a section through the housing of the air conditioner in a schematic illustration.

FIG. 1 shows a housing cover 1 that is assigned a blower motor mounting 2 and a blower motor 3. The blower motor 3 has a motor axle 4 with impellers 5, 5′. The impellers 5 and 5′ are assigned spiral housings 6, 6′ but only the under parts 8 and 8′ of the spiral housing 6, 6′ are illustrated from FIG. 1. The housing cover 1 is also assigned a motor regulator 7.

FIG. 2 illustrates the arrangement of the housing cover 1 on a housing 9 of an air conditioner 10 (not illustrated in more detail) of an air conditioning system for a motor vehicle. The most varied units of the air conditioner 10 are arranged in the interior 11 of the housing 9 (not illustrated). The housing 10 has a housing opening 12 that can be sealed by means of the housing cover 1. The housing cover 1 is held for this purpose in the region of the opening rim of the housing opening 12 by means of suitable, releasable fastening means. Some of the abovementioned assemblies of the air conditioner are fastened on the underside 13 of the housing cover 1. These units are illustrated schematically in FIG. 2 and denoted by 14.

In accordance with FIG. 1, the housing cover 1 has the blower motor mounting 2 on its inner side 13 approximately in the middle. The blower motor mounting 2 is designed as a mounting with a decoupler 15, that is to say it has a vibration-absorbing design in order to reduce the transmission of vibrations of the blower motor 3 to the housing cover 1. To provide ease of assembly, a receptacle 16 on which the housing motor mounting 2 can be fastened is constructed integrally on the inner side 13 of the housing cover 1. It is preferred for the receptacle 16 also to be constructed in the course of the injection molding process of the housing cover 1 consisting of plastic. The blower motor 3 is fastened on the top side 17 of the blower motor mounting 2. Its motor axle 4 is of continuous design, that is to say it has two shaft supports 18, 18′ onto which the impellers 5, 5′ are firmly pressed. The impellers 5, 5′ are illustrated only schematically in FIG. 1, that is to say the blower vanes and the like cannot be detected. The arrangement is made in such a way that with reference to each of the impellers 5, 5′ a section 19 or 19′ of the spiral housing 6 or 6′ proceeds from the inner side 13. The sections 19 and 19′ are preferably produced integrally with the housing cover 1. The sections 19, 19′ are housing halves of the spiral housing 6, 6′, that is to say their upper rim 20 or 20′ is situated at a level (distance from the inner side 13 of the housing cover 1) that corresponds to the height arrangement of the motor axle 4. Consequently, the second half, not illustrated, of each spiral housing 6, 6′ can be pushed from above over the respective impeller 5, 5′ in each case, and be connected to the corresponding section 19 or 19′ by means of suitable coupling elements. Each spiral housing 6, 6′ is assigned at least one air inlet and air outlet opening (not illustrated). As an alternative to fastening the second halves of the spiral housings 6, 6′ on the first halves (sections 19, 19′) it can also be provided that the second halves are permanently arranged in the housing 9 and are automatically assigned to the first halves when the housing cover 1 is inserted into the housing opening 12. As FIG. 1 shows, the outer wall 21, 21′ of each section 19, 19′ is designed in a fashion lengthened upward in the region of the associated impeller 5 or 5′, this wall 21, 21′ simultaneously forming an end wall of the housing cover 1.

A receptacle 22 for the motor regulator 7 is constructed on the inner side 13 of the housing cover 1 in the region between the blower motor 3 and the impeller 5′. This receptacle 22 is likewise of integral configuration with the housing cover 1 and serves for receiving the motor regulator 7. The motor regulator 7 is therefore removably fastened on the housing cover 1.

The blower motor 3 is designed as an electric motor; the motor regulator 7 is likewise an electric component. These two components are connected to one another via electric cables (not illustrated), the cables preferably likewise being fastened on the inner side 13 of the housing cover 1 by means of suitable fastening elements (in particular clips).

The following function results.

If, for example, the blower motor 3 of the air conditioner 10 is to be examined more closely during an inspection or upon the occurrence of the fault message, it is necessary to open the housing 9. Since, according to the invention, the abovementioned assemblies of the air conditioner 10 are arranged on the inner side 13 of the housing cover 1, the housing cover 1 can be removed, altogether with the assemblies arranged thereon, in a simple way by releasing an appropriate fastening device. In this way, firstly, the housing opening 12 is released such that there is access to the interior 11 of the housing 9 of the air conditioner 1 and, secondly, there is optimum accessibility to the components located on the housing cover 1, since the housing cover 1 can be handled simply by removing it from the motor vehicle. The ease of accessibility reduces the assembly/repair costs and also permits reliable operation. If, for example, the blower motor 3 is exchanged in the event of a defect, all the fastening sites and elements that are to be screwed off are freely accessible. After the motor exchange, the housing cover, together with the associated unit/components, is reassigned to the air conditioner 10 in a simple way. In particular, the procedure is such that the assemblies on the housing cover 1 are cohesive assemblies. What is understood thereby are the assemblies that form a functional unit in the sense of a module (for example air supply or cooling unit or the like) such that all the components belonging to this functional unit are always accessible in the case of a removal.

1. An air conditioner of an air conditioning system of a motor vehicle, comprising a housing, having a removable housing cover, in which the following components are arranged: at least one blower motor, at least one impeller, at least one blower motor mounting and at least one motor regulator, characterized in that the components are arranged on the housing cover (1), in particular on its inner side (13).

2. The air conditioner as claimed in claim 1, characterized in that the blower motor mounting (2) comprises a vibration isolator (15).

3. The air conditioner as claimed in claim 1, characterized in that the impeller (5, 5′) is assigned a spiral housing (6, 6′) of which a section (19, 19′) is located on the housing cover (1).

4. The air conditioner according to claim 1, characterized in that the section (19, 19′) of the spiral housing (6, 6′) is designed in one piece with the housing cover (1).

5. The air conditioner according to claim 1, characterized in that the housing cover (1) has a receptacle (16) for the blower motor mounting (2) and/or a receptacle (22) for the motor regulator (7).

6. The air conditioner according to claim 1, characterized in that other components of the air conditioner (10) are arranged on the housing cover (1), in particular at least one positioning motor and/or at least one air flap and/or at least one temperature sensor and/or at least one air filter and/or at least one electric cable.

7. The air conditioner according to claim 1, characterized in that a blower motor (3), two impellers (5, 5′), a blower motor mounting (2) and a motor regulator (7) are arranged on the housing cover (1).
